(19) United States
(12) Patent Application Publication
(10) Pub. No.: US 2018/0285826 A1
(43) Pub. Date: Oct. 4, 2018

(54) WORKPLACE FILE MANAGEMENT SYSTEM, WORKPLACE FILE MANAGEMENT METHOD, AND PROGRAM

(71) Applicant: KONICA MINOLTA, INC., Tokyo (JP)

(72) Inventor: Hirokazu Sasamoto, Osaka (JP)

(73) Assignee: KONICA MINOLTA, INC., Tokyo (JP)

(21) Appl. No.: 15/928,204

(22) Filed: Mar. 22, 2018

(30) Foreign Application Priority Data
Mar. 31, 2017 (JP) 2017-071090

(51) Int. Cl. G06Q 10/10; G06F 11/30; G06F 11/34

(52) U.S. Cl. CPC G06Q 10/1091; G06F 11/3495; G06F 11/3034

(57) ABSTRACT

A workplace file management system includes: a workplace file information generator that generates workplace file information in which a file satisfying a condition set in advance in files stored in a storage device is registered as a workplace file; and an access log generator that generates workplace file access information as information specifying an individual accessing the workplace file and time.

The entire disclosure of Japanese patent Application No. 2017-071090, filed on Mar. 31, 2017, is incorporated herein by reference in its entirety.

### BACKGROUND

### Technological Field

The present disclosure relates to a workplace file management system, a workplace file management method, and a program.

### Description of the Related Art

In the related art, various proposes have been made with respect to a management method of working time in a case where an employee works by connecting a computer at home to a computer in the office. For example, JP 2007-188210 A discloses an attendance management system of acquiring operation time of a worker by counting only a log of an application name and a file name designated in advance.

JP 11-85859 A discloses a homeworking time management method of managing working time by using a name of a program, which is operated by an individual with a computer at home, and start time of the program as ending time.

JP 5017174 B2 discloses a collection method of working status information, in which in a thin client type information processing system, substantial operation time of a worker is derived on the basis of an operation place and operation time of the worker.

JP 2008-97554 A discloses a working history recording device automatically preparing a daily report by using a name of a document, which is opened in an application program displayed as an active window.

However, in the technology described in JP 2007-188210 A, it is necessary for an administrator to designate all documents, which can be a working target, as the working target, and thus, the technology is cumbersome. A document of a working target, which is prepared when the administrator is absent, is not designated as the working target, and thus, there is a possibility that a work status is not accurately counted as the working time. In the technologies described in JP 11-85859 A. JP 5017174 B2, and JP 2008-97554 A, it is not possible to grasp whether or not a document, which is a processing target, is relevant to the work, aid thus, there is a possibility that a work status is not accurately counted as the working time.

### SUMMARY

The present disclosure has been made in consideration of such circumstances, and an object thereof is to provide a workplace file management system, a workplace file management method, and a program, in which it is possible to accurately count a work status as working time, without requiring a cumbersome operation.

To achieve the abovementioned object according to an aspect of the present invention, a workplace file management system reflecting one aspect of the present invention comprises: a workplace file information generator that generates workplace file information in which a file satisfying a condition set in advance in files stored in a storage device is registered as a workplace file; and an access log generator that generates workplace file access information as information specifying an individual accessing the workplace file and time.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram for illustrating the concept of management of working time in a file management system according to an embodiment of the present disclosure;

FIG. 2 is a diagram schematically illustrating a hardware configuration of the file management system;

FIG. 3 is a diagram schematically illustrating a property of a file stored in a file storage;

FIG. 4 is a diagram illustrating an example of information stored in a management information storage;

FIG. 5 is a diagram illustrating an example of the contents of the workplace file information:

FIG. 6 is a diagram illustrating an example of the contents of a workplace file log;

FIG. 7 is a diagram for illustrating an example of generation and use aspects of an access log of a workplace file in the file management system of an embodiment;

FIG. 8 is a flowchart of processing executed by a processor of a management server in order to generate workplace file information:

FIG. 9 is a flowchart of an example of a subroutine of workplace determination processing of step S30;

FIG. 10 is a flowchart of another example of the subroutine of the workplace determination processing of step S30;

FIG. 11 is a flowchart of still another example of the subroutine of the workplace determination processing of step S30:

FIG. 12 is a flowchart of still another example of the subroutine of the workplace determination processing of step S30;

FIG. 13 is a flowchart of processing for generating the workplace file log (FIG. 6);

FIG. 14 is a flowchart of processing for using the access log of the workplace file in management of working time of an individual;

FIG. 15 is a diagram illustrating an example of an access log after the working time of a user M; and

FIG. 16 is a flowchart of processing for using the access log of the workplace file in management of the access of the file.

### DETAILED DESCRIPTION OF EMBODIMENTS

Hereinafter, one or more embodiments of a file management system according to the present invention will be described with reference to the drawings. However, the scope of the invention is not limited to the disclosed embodiments. In the following description, the same reference numerals are applied to the same components and the same constituents. Names and functions thereof are also identical to each other. Therefore, the description thereof will not be repeated.

### 1. Outline of Processing of File Management System

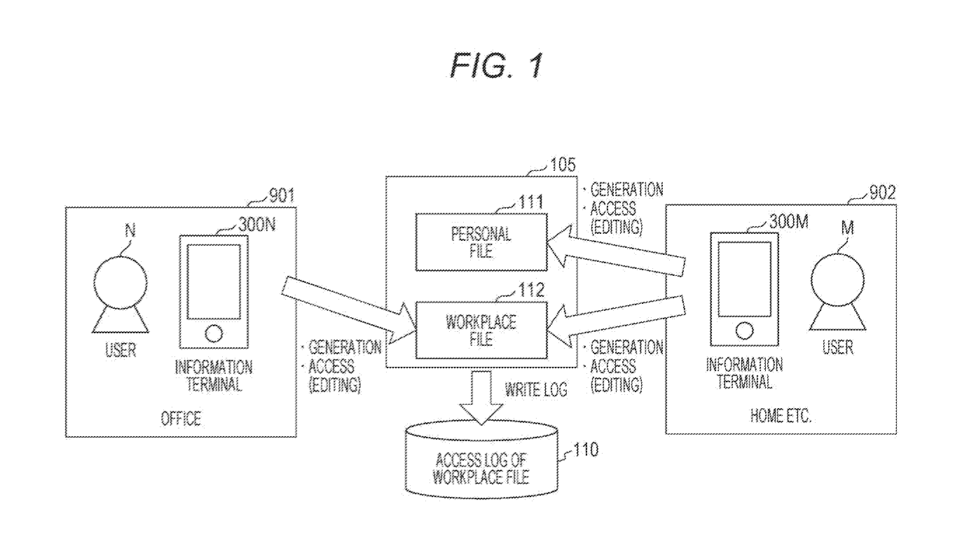

FIG. 1 is a diagram for illustrating the concept of management of working time in a file management system according to an embodiment of the present disclosure. As illustrated in FIG. 1, in the file management system, a file stored in a storage device 105 is sorted into a personal file 111 and a workplace file 112, according to a predetermined condition.

The workplace file is a file which is used at work. The personal file is a file other than the workplace file. In an embodiment, working time of an individual is calculated by using an access log with respect to the workplace file. The access log includes a log indicating that the user accesses the file in order to edit the file.

The file management system includes a management server. The management server, for example, sorts a file generated by a terminal, which is positioned in an office 901, into the workplace file 112, and sorts a file generated by a terminal, which is positioned at home 902 (a place other than the office 901), into the personal file 111.

The management server generates the access log of the workplace file (a workplace file log of FIG. 6 described below) by using information specifying an individual accessing the workplace file 112, and time. For example, in a case where a user N positioned in the office 901 accesses the workplace file 112 by using an information terminal 300N, the management server adds a log of the access to the access log of the workplace file. In a case where the user M positioned at home 902 accesses the workplace file 112 by using an information terminal 300M, the management server adds a log of the access to the access log of the workplace file. In a case where the user M positioned at home 902 accesses the personal file 111 by using the information terminal 300M, the management server does not add a log of the access to the access log of the workplace file.

### 2. Hardware Configuration

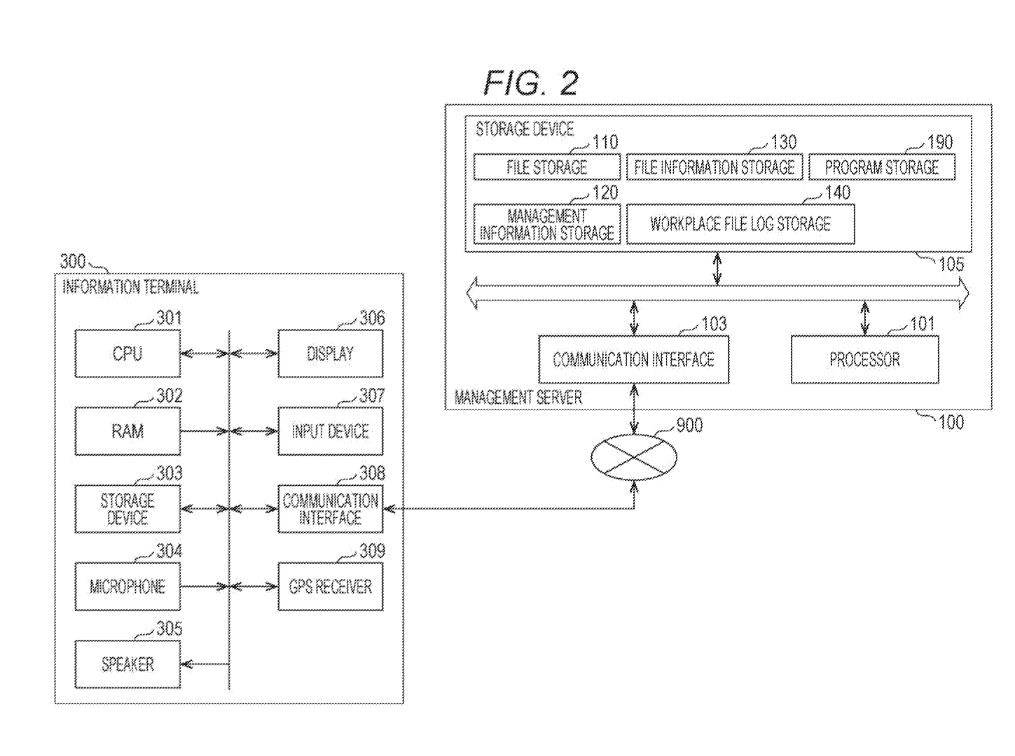

FIG. 2 is a diagram schematically illustrating a hardware configuration of the file management system. As illustrated in FIG. 2, the file management system includes a management server 100 and an information terminal 300. In the following description, the information terminal 300M and the information terminal 300N of FIG. 1 will be collectively referred to as the “information terminal 300”. An example of the management server 100 is a server for managing a working situation of the individual in the office, and for example, is realized by a general-purpose computer. An example of the information terminal 300 is realized by a personal computer. The management server 100 and the information terminal 300 are connected to each other through a network 900 (a local area network or the like). Hereinafter, a hardware configuration of each of the management server 100 and the information terminal 300 will be described.

(Management Server 100)

The management server 100 includes a processor 101, a communication interface 103, and the storage device 105. The communication interface 103, for example, is realized by a local area network (LAN) card. The processor 101 transmits and receives information with respect to other devices on the network 900, by using the communication interface 103.

The storage device 105, for example, is realized by a hard disk, but is not limited thereto. The storage device 105 includes a file storage 110, a management information storage 120, a file information storage 130, a workplace file log storage 140, and a program storage 190.

The file storage 110 stores a document file (hereinafter, simply referred to as a “file”). In an embodiment, each of the files stored in the file storage 110 includes a property of the file. In another embodiment, the file storage 110 stores information indicating the property of each of the files stored in the file storage 110.

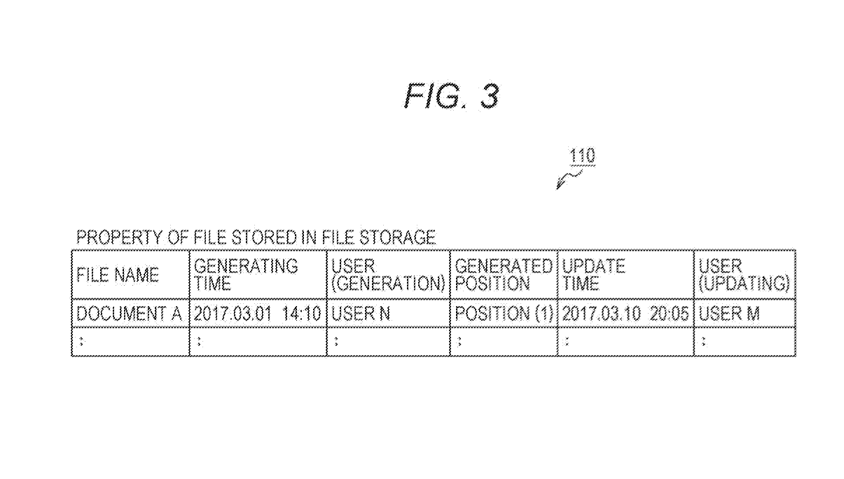

FIG. 3 is a diagram schematically illustrating the property of the file stored in the file storage 110. As illustrated in FIG. 3, the property includes a file name, a generating time, a user (generation), a generated position, update time, and a user (updating). The file name is a name allocated to the file. The generating time indicates time when the file is generated. The user (generation) indicates the user of the device outputting an instruction of generating the file (for example, the user who logs in the device at the time of outputting the instruction). The generated position indicates position information of the terminal outputting the instruction of generating the file, at a time point where the instruction is output. The update time indicates time when the file is most recently updated. The user (updating) indicates the user of the device outputting an instruction of updating the file (for example, the user who logs in the device at the time of outputting the instruction).

The example of FIG. 3 illustrates that a file having a file name of “document A” is generated by operating a device in “position (1)” at “14:10 on March 1, 2017”, by “user N”, and the file is updated at 20:05 on Mar. 10, 2017, by the user M.

Furthermore, an example of “instruction to be generated” is an instruction of designating the file storage 110 as a storage destination of a newly generated file. Another example is an instruction of storing (copying or moving) a file stored in the other storage destination in the file storage 110.

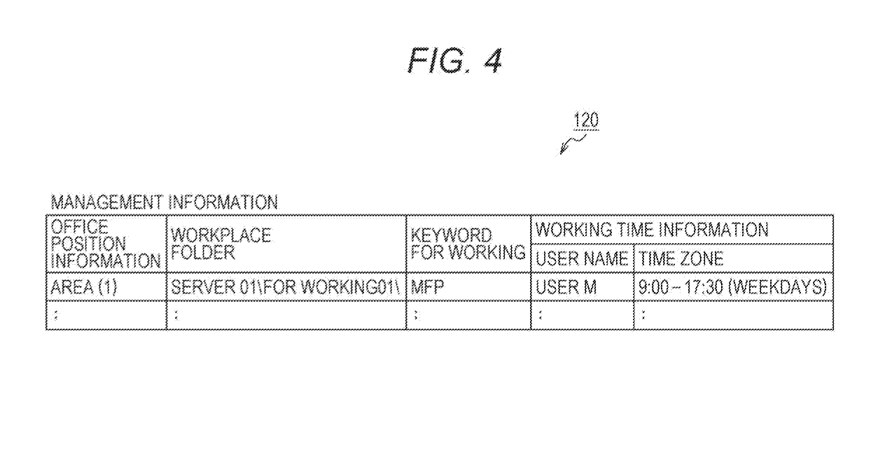

Returning to FIG. 2, the management information storage 120 stores information for managing the work. FIG. 4 is a diagram illustrating an example of information stored in the management information storage 120. As illustrated in FIG. 4, the management information storage 120 includes office position information, workplace folder information, a keyword for working, and working time information.

The office position information defines an area to be specified as the office, as exemplified as “area (1)” in FIG. 4. In an embodiment, it is confirmed that an information terminal positioned in the area specified as “area (1)” is positioned in the office.

The workplace folder information defines information specifying a folder in which a file for working is stored (in the example of FIG. 4, a pass), as exemplified as “server 01¥for working01¥” in FIG. 4. In an embodiment, it is confirmed that a file stored in a folder specified as “server 01¥for working01¥” is the file for working.

The keyword for working defines a keyword which is expected to be included in a document specified by the file for working, as exemplified as “MFP” in FIG. 4. That is, in the file management system of an embodiment, it is confirmed that a file of a document including a keyword of “MFP” is the file for working.

The working time information is working time set for each of the users. In the example of FIG. 4, time from 9 a.m. (9:00) to 5:30 p.m. (17:30) on weekdays is set as the working time, with respect to the user M.

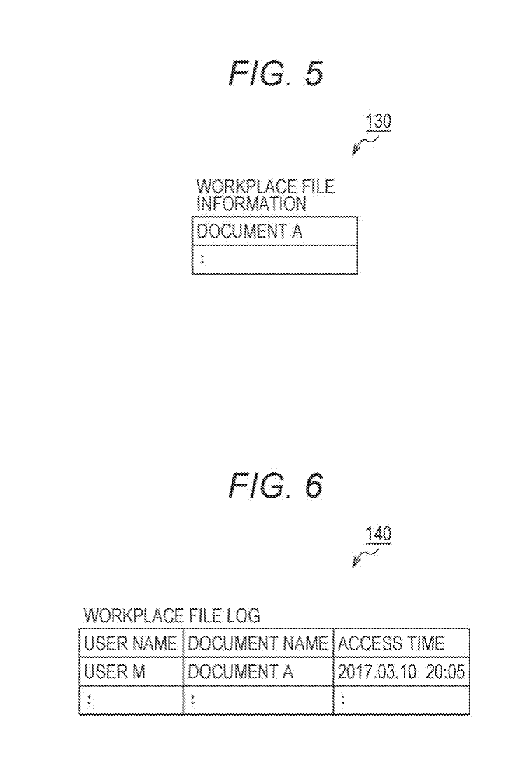

Returning to FIG. 2, the file information storage 130 stores information specifying the workplace file (workplace file information). FIG. 5 is a diagram illustrating an example of the contents of the workplace file information. In the example of FIG. 5, the workplace file information includes a file name such as “document A”. In an embodiment, it is confirmed that a file having the file name of “document A” is the file for working (relevant to the work).

Returning to FIG. 2, the workplace file log storage 140 stores an access log with respect to the file for working (the workplace file log), in the access logs of the files stored in the file storage 110. FIG. 6 is a diagram illustrating an example of the contents of the workplace file log. As illustrated in FIG. 6, the workplace file log is associated with a user name, a document name, and access time. The example of FIG. 6 illustrates that the user M accesses “document A”, which is an example of the workplace file, at 20:05 on Mar. 10, 2017.

Returning to FIG. 2, the program storage 190 stores a program to be executed by the processor 101. Furthermore, the processor 101 may execute a program stored in a storage device outside of the management server 100.

(Information Terminal 300)

The information terminal 300 includes a CPU 301, a random access memory (RAM) 302, a storage device 303, a microphone 304, a speaker 305, a display 306, an input device 307, a communication interface 308, and a GPS receiver 309. The respective elements in the information terminal 300 are connected to each other by an internal bus.

The CPU 301 is an example of a processor executing processing for controlling the information terminal 300. The RAM 302 functions as a work area at the time of executing the processing in the CPU 301. The storage device 303 stores a program to be executed by the CPU 301, and data to be used for executing the program, in a non-volatile manner.

The microphone 304 outputs input sound to the CPU 301. The speaker 305 outputs the sound according to an instruction from the CPU 301. The display 306 displays an image representing a processing result of the program executed by the CPU 301. The input device 307 receives an input operation. The input device 307, for example, is a touch sensor disposed on a hardware button, and/or, the display 306.

The communication interface 308, for example, is realized by a network card. The CPU 301 transmits and receives data with respect to the other device through the communication interface 308.

The global positioning system (GPS) receiver 309 calculates the position of the information terminal 300 by using an electrical wave received from a GPS satellite, and outputs a calculation result to the CPU 301.

### 3. Generation and Use of Access Log of Workplace File

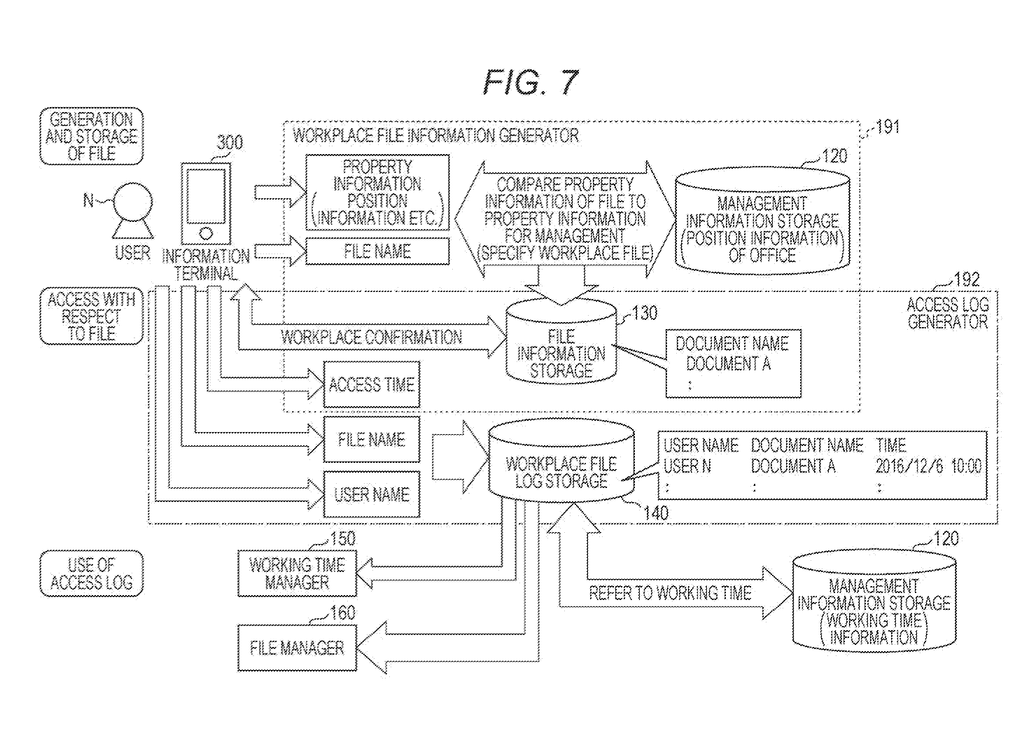

FIG. 7 is a diagram for illustrating an example of generation and use aspects of the access log of the workplace file in the file management system of an embodiment. FIG. 7 illustrates a workplace file information generator 191 and an access log generator 192 as the function of the management server 100.

The workplace file information generator 191 generates workplace file information (stored in the file information storage 130 of FIG. 2). More specifically, the workplace file information generator 191 determines whether or not each of the files stored in the file storage 110 is the workplace file. In an embodiment, it is determined whether or not the file is the workplace file, according to whether or not the position information of the file (“generated position” of FIG. 3) is in the area specified by the office position information. The workplace file information generator 191 stores the file name of the file, which is determined as the workplace file, in the file information storage 130, as the workplace file information.

The access log generator 192 generates the access log of the workplace file (the workplace file log of FIG. 6). In an embodiment, the access log generator 192 extracts the access log of the workplace file from the access logs of all of the files stored in the file storage 110, and thus, generates the access log of the workplace file. The access log generator 192 stores the generated access log of the workplace file in the workplace file log storage 140.

The management server 100 may further function as a working time manager 150 and a file manager 160. The working time manager 150 generates information relevant to the working time of each of the users. In an embodiment, the working time manager 150 generates information specifying overtime hours of the user. More specifically, the working time manager 150 specifies a period during which the user accesses the workplace file, and determined whether or not the period is after the working time of the user, with reference to the working time of the management information (FIG. 4). In a case where it is determined that the period is after the working time of the user, the working time manager 150 specifies the period as the overtime hours of the user.

The file manager 160 detects the occurrence of a state in which each of the users accesses the workplace file after the working time of the user. In a case where the state occurs, the file manager 160 may transmit an e-mail to the administrator of the file management system, and thus, may notify the occurrence of the state.

### 4. Generation of Workplace File Information

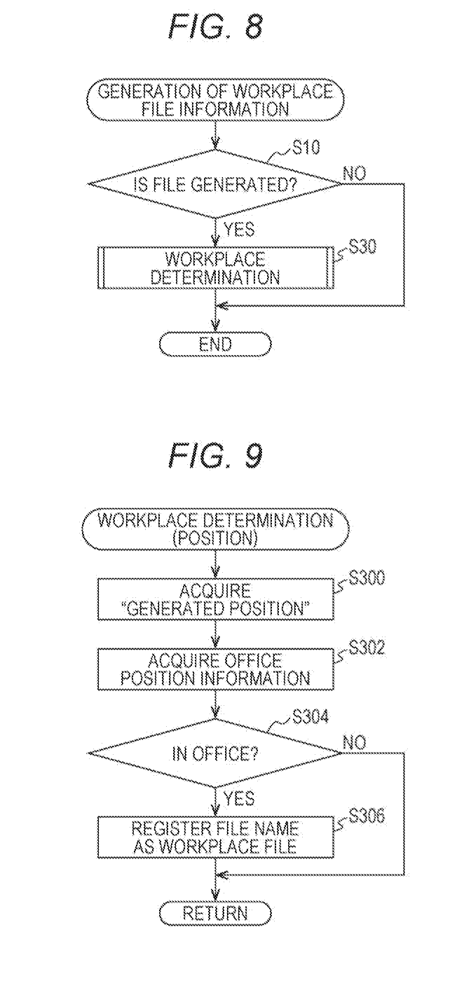

The generation of the workplace file information (FIG. 5) will be described with reference to FIGS. 8 to 12. FIGS. 8 to 12 are flowcharts of processing to be executed by the processor 101 of the management server 100 in order to generate the workplace file information. The processor 101 executes the processing of FIGS. 8 to 12 as the workplace file information generator 191. In an embodiment, the processor 101 executes a given program, and thus, the processing illustrated in each of the flowcharts is realized.

With reference to FIG. 8, in step S10, the processor 101 determines whether or not a new file is registered in the file storage 110. For example, the processor 101 executes the processing of FIG. 8 at regular time intervals. In step S10, the processor 101 compares a list of the files in the file storage 110 at a time point of executing previous processing of FIG. 8, to a list of the files in the file storage 110 at a time point of executing current processing of FIG. 8, and thus, determines whether or not a new file is registered in the file storage 110. In a case where it is determined that a new file is registered (YES in step S10), the processor 101 allows the control to proceed to step S30. In a case where it is determined that a new file is not registered (NO in step S10), the processor 101 ends the processing of FIG. 8.

In step S30, the processor 101 executes processing of determining whether or not the newly registered file is the workplace file information (workplace determination). After that, the processor 101 ends the processing of FIG. 8.

Hereinafter, four types of subroutines of the processing of step S30 will be described with reference to FIGS. 9 to 12. In the file management system, at least one of four types of subroutines is executed, and thus, the workplace file is specified.

(FIG. 9: Specifying “Workplace File” According to Position Information)

FIG. 9 is a flowchart of an example of the subroutine of the workplace determination processing of step S30, and illustrates processing of determining whether or not the file is “workplace file information”, according to the position information of the terminal instructing the generation of the file.

With reference to FIG. 9, in step S300, the processor 101 acquires “generated position” of the file, with reference to the property of the file (FIG. 3) determined as being newly generated in step S10 (FIG. 8).

In step S302, the processor 101 acquires the office position information (FIG. 4).

In step S304, the processor 101 determines whether or not “generated position” acquired in step S300 is in the area specified by the office position information which is acquired in step S302. In a case where it is determined that “generated position” is in the area (YES in step S304), the processor 101 allows the control to proceed to step S306. In a case where it is determined that “generated position” is not in the area (NO in step S304), the processor 101 ends the processing of FIG. 9 as it is.

In step S306, the processor 101 registers “file name” of the file, which is determined as being newly generated in step S10, as the workplace file information (FIG. 5), and ends the processing of FIG. 9.

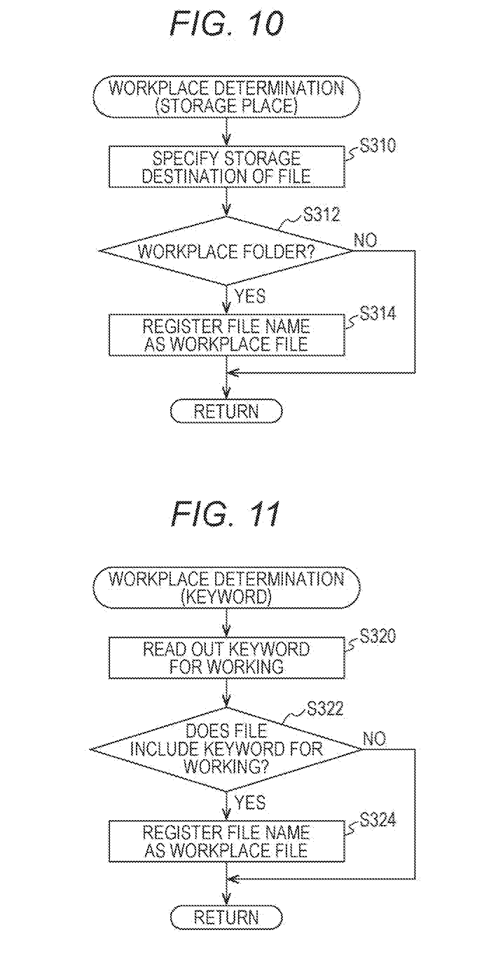

(FIG. 10: Specifying “Workplace File” According to Storage Place)

FIG. 10 is a flowchart of another example of the subroutine of the workplace determination processing of step S30, and illustrates processing of determining whether or not the file is “workplace file information”, according to a place where the file is stored.

With reference to FIG. 10, in step S310, the processor 101 specifies the storage destination of the file, which is newly generated in step S10 (FIG. 8).

In step S312, the processor 101 determines whether or not the storage destination specified in step S310 is registered as the folder for working (FIG. 4). In a case where it is determined that the storage destination is registered as the folder for working (YES in step S312), the processor 101 allows the control to proceed to step S314. In a case where it is determined that the storage destination is not registered as the folder for working (NO in step S312), the processor 101 ends the processing of FIG. 10.

In step S314, the processor 101 registers “file name” of the file, which is determined as being newly generated in step S10, in the workplace file information (FIG. 5), and ends the processing of FIG. 10.

(FIG. 11: Specifying “Workplace File” According to Keyword)

FIG. 11 is a flowchart of still another example of the subroutine of the workplace determination processing of step S30, and illustrates processing of determining whether or not the file is “workplace file information”, according to the keyword included in the file.

With reference to FIG. 1I, in step S320, the processor 101 reads out the keyword for working (FIG. 4).

In step S322, the processor 101 determines whether or not the file, which is determined as being newly generated in step S10, includes the keyword for working. In a case where it is determined that the file includes the keyword for working (YES in step S322), the processor 101 allows the control to proceed to step S324. In a case where it is determined that the file does not include the keyword for working (NO in step S322), the processor 101 ends the processing of FIG. 11.

In step S324, the processor 101 registers “file name” of the file, which is determined as being newly generated in step S10, in the workplace file information (FIG. 5), and ends the processing of FIG. 11.

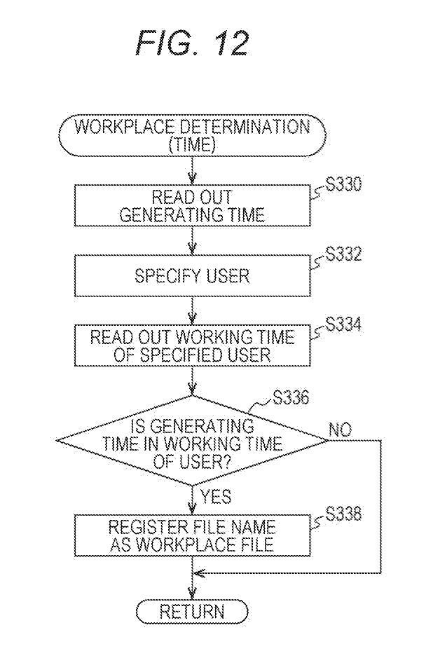

(FIG. 12: Specifying “Workplace File” According to Time when File is Generated)

FIG. 12 is a flowchart of still another example of the subroutine of the workplace determination processing of step S30, and illustrates processing of determining whether or not the file is “workplace file information”, according to the time when the file is generated.

In step S330, the processor 101 reads out the generating time (FIG. 3) of the file, which is determined as being newly generated in step S10.

In step S332, the processor 101 reads out information specifying the user (“user (generating)” of FIG. 3) generating the file, which is determined as being newly generated in step S10.

In step S334, the processor 101 reads out the working time (“working time information” of FIG. 4) of the user, which is specified in step S332.

In step S336, the processor 101 determines whether or not the generating time read out in step S330 is in the working time read out in step S334. In a case where it is determined that the generating time is in the working time (YES in step S336), the processor 101 allows the control to proceed to step S338. In a case where it is determined that the generating time is not in the working time (NO in step S336), the processor 101 ends the processing of FIG. 12.

In step S338, the processor 101 registers “file name” of the file, which is determined as being newly generated in step S10, in the workplace file information (FIG. 5), and ends the processing of FIG. 12.

In an embodiment, the processor 101 generates the workplace file information by executing at least one of four types of processing, which have been described with reference to FIGS. 9 to 12.

In another embodiment, the processor 101 executes a combination of a plurality of processing in four types of processing, and thus, generates the workplace file information. In an example of the combination, the processor 101 sequentially executes the processing of FIGS. 9 to 12. That is, the processor 101 executes the processing of FIG. 9, and in a case where it is determined that the file, which is determined as being newly generated in step S10, is not the workplace file (NO in step S304), executes the processing of FIG. 10. In a case where it is determined that the file is not the workplace file (NO in step S312), the processor 101 executes the processing of FIG. 11. In a case where it is determined that the file is not the workplace file (NO in step S322), the processor 101 executes the processing of FIG. 12.

### 5. Generation of Workplace File Log

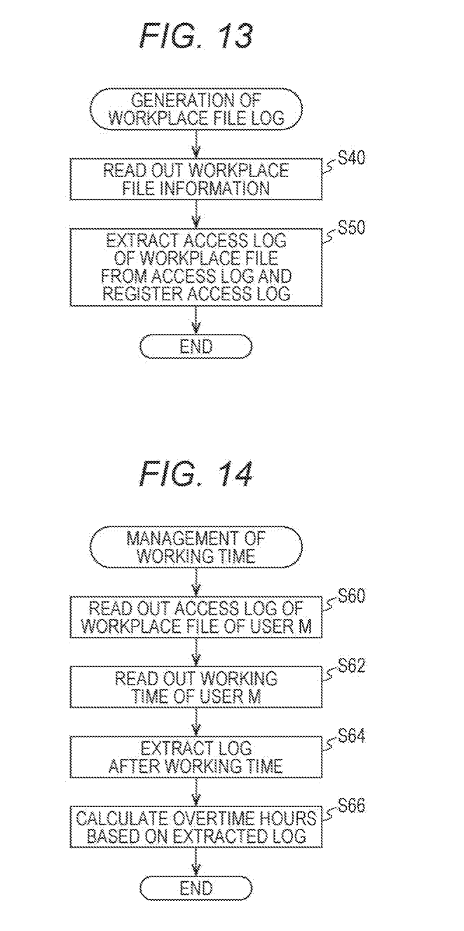

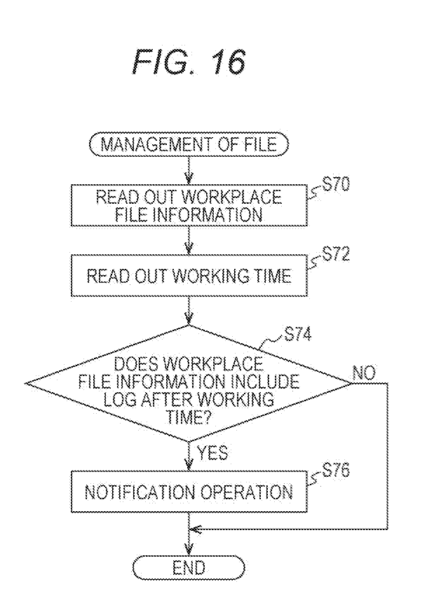

FIG. 13 is a flowchart of processing for generating the workplace file log (FIG. 6). The processor 101 executes the processing of FIG. 13 as the access log generator 192 (FIG. 7). In an embodiment, the processor 101 executes the processing of FIG. 13 at regular time intervals and/or immediately before processing of FIG. 14 or FIG. 16 described below is executed.

With reference to FIG. 13, the processor 101 reads out the workplace file information (FIG. 5) in step S40.

In step S50, the processor 101 extracts the access log of the file included in the workplace file information, which is read out in step S40, from the access logs of the files stored in the file storage 110, and registers the extracted access log as the workplace file log.

### 6. Use of Access Log of Workplace File (Working Time Management)

FIG. 14 is a flowchart of processing for using the access log of the workplace file in the management of the working time of the individual. The processing of FIG. 14 relates to the calculation of the overtime hours of the individual as an example of the management of the working time. The processor 101 executes the processing of FIG. 14 as the working time manager 150 (FIG. 7). Furthermore, FIG. 14 illustrates processing in a case where “user M” is designated as a target of the management of the working time.

With reference to FIG. 14, in step S60, the processor 101 reads out the access log of the user M, in the workplace file log (FIG. 6).

In step S62, the processor 101 reads out the working time of the user M (FIG. 4).

In step S64, the processor 101 extracts the access log after the working time of the user M, in the access logs of the user M, which are read out in step S60. For example, in a case where the working time of the user M is time from 9:00 to 17:30 on weekdays, the processor 101 extracts a log from 0:00 to 8:59 on weekdays, a log from 17:31 to 23:59 on weekdays, and all logs of holidays, in the access logs of the user M.

In step S66, the processor 101 calculates the overtime hours of the user M, by using the access log of the user M after the working time, on the basis of the access log extracted in step S64.

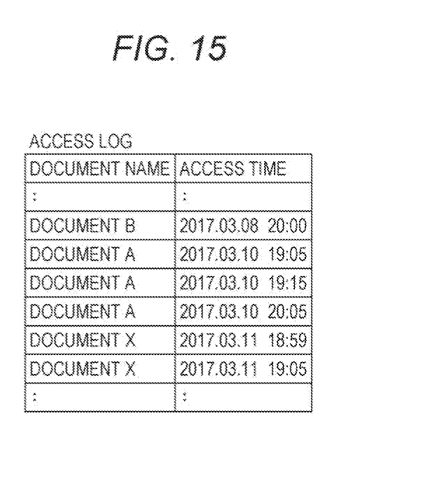

FIG. 15 is a diagram illustrating an example of the access log after the working time of the user M, which is extracted in step S64. In the example of FIG. 15, in a case of Mar. 10, 2017, the earliest log is a log at 19:05, and the latest log is a log at 20:05. In such a case, in an embodiment, the processor 101 specifies that the period from 19:05 to 20:05 is the overtime hours of the user M.

### 7. Use of Access Log of Workplace File (File Management)

FIG. 16 is a flowchart of processing for using the access log of the workplace file in the management of the access of the file. The processor 101 executes the processing of FIG. 16 as the file manager 160 (FIG. 7).

With reference to FIG. 16, in step S70, the processor 101 reads out the workplace file information.

In step S72, the processor 101 reads out the working time of each of the users (FIG. 4) of the file management system.

In step S74, the processor 101 determines whether or not the workplace file information, which is read out in step S70, includes the log after the working time of the user. For example, the processor 101 determines whether or not each log of the workplace file information is at time after the working time of the user according to the log. In a case where it is determined that the workplace file information includes the log after the working time of the user (YES in step S74), the processor 101 allows the control to proceed to step S76. In a case where it is determined that the workplace file information does not include the log after the working time of the user (YES in step S74), the processor 101 ends the processing of FIG. 16.

In step S76, the processor 101 executes a notification operation for notifying that there is an access with respect to the workplace file after the working time. An example of the notification operation is transmission of an e-mail with respect to the administrator of the file management system. The e-mail may include information specifying the accessed workplace file (for example, the file name). The e-mail may include information specifying the user who accesses the workplace file (for example, the user name, or the department of the user).

### 8. Abstract of Disclosure

The present disclosure can be abstracted as follows.

(1) A workplace file management system (the management server 100) includes a workplace file information generator (the workplace file information generator 191) generating the workplace file information (“workplace file information” of FIG. 5) in which a file satisfying a condition set in advance in the files stored in the storage device (the storage device 105) is registered as the workplace file.

The workplace file management system (the management server 100) includes an access log generator (the access log generator 192) generating workplace file access information (“workplace file log” of FIG. 6), as the information specifying the individual accessing the workplace file, and the time.

Furthermore, the file to be determined whether or not the workplace file is not limited to the file stored in the storage device 105 of the management server 100. That is, it is not necessary for the management server 100 to include a storage device storing the file, and may determine whether or not a file stored in an external storage device is the workplace file.

According to the present disclosure, the workplace file management system objectively determines whether or not the file is the workplace file, according to the condition described above. Accordingly, it is possible for the administrator to accurately calculate the working time of the individual, without requiring a cumbersome operation, and the administrator arbitrarily sets the workplace file, and thus, it is possible to prevent a problem in which the working time of the individual is not capable of being accurately calculated.

(2) The storage device may store the information specifying the position information of the terminal generating the file (“generated position” of FIG. 3). The condition set in advance may be that the file stored in the storage device is generated in a predetermined place (“office position information” of FIG. 4) (FIG. 9).

(3) The condition set in advance may be that the file stored in the storage device includes a predetermined keyword (“keyword for working” of FIG. 4) (FIG. 11).

(4) The condition set in advance may be that the file is stored in a predetermined area of the storage device (“folder for working” of FIG. 4) (FIG. 10).

(5) The storage device may store information specifying the time when the file is generated (“generating time” of FIG. 3). The condition set in advance may be that the time when the file is generated is in a predetermined time range (in the working time of the user) (FIG. 12).

(6) The workplace file management system may further include the working time manager (the working time manager 150) calculating the working time of each of the individuals by specifying a period during which each of the individuals accesses the workplace file (in the processing of FIG. 14, time from the log at the earliest time to the log at the latest time after the working time), with the workplace file access information.

(7) The workplace file management system may further include a monitor (the file manager 160, step S74) determining whether or not the time when the individual accesses the workplace file is in the working time of the individual, with respect to each of the individuals. The monitor may notify predetermined information in a case where the individual accesses the workplace file after the working time of the individual (step S76).

(8) A workplace file management method executed by a computer for managing the time when the file stored in the storage device is used for working is provided. The workplace file management method causes the computer to perform a step of generating the workplace file information in which the file satisfying the condition set in advance in the files stored in the storage device is registered as the workplace file (FIG. 8), and a step of generating the workplace file access information as the information specifying the individual accessing the workplace file, and the time (FIG. 13).

Although embodiments of the present invention have been described and illustrated in detail, the disclosed embodiments are made for purposes of illustration and example only and not limitation. The scope of the present invention should be interpreted by terms of the appended claims and intended to include the meanings equivalent to the claims and all changes within the scope. In addition, the present invention described in the embodiments and each modification is intended to be implemented as much as possible independently or in combination.

What is claimed is:

1. A workplace file management system comprising:
a workplace file information generator that generates workplace file information in which a file satisfying a condition set in advance in files stored in a storage device is registered as a workplace file; and
an access log generator that generates workplace file access information as information specifying an individual accessing the workplace file and time.

2. The workplace file management system according to claim 1,
wherein the storage device stores information specifying position information of a terminal which generates the file, and
the condition set in advance is that the file stored in the storage device is generated at a predetermined place.

3. The workplace file management system according to claim 1,
wherein the condition set in advance is that the file stored in the storage device includes a predetermined keyword.

4. The workplace file management system according to claim 1,
wherein the condition set in advance is stored in a predetermined area of the storage device.

5. The workplace file management system according to claim 1,
wherein the storage device stores information specifying time when the file is generated, and
the condition set in advance is that the time when the file is generated is in a predetermined time range.

6. The workplace file management system according to claim 1, further comprising:
a working time manager that calculates working time of each individual by specifying a period during which the individual accesses the workplace file of each of the individuals, with the workplace file access information.

7. The workplace file management system according to claim 1, further comprising:
a monitor that determines whether or not time when each individual accesses the workplace file is in working time of the individual,
wherein the monitor notifies predetermined information in a case where the individual accesses the workplace file after the working time of the individual.

8. A workplace file management method executed by a computer for managing time when a file is used for working, the method causing the computer to perform:
generating workplace file information in which a file satisfying a condition set in advance in files stored in a storage device is registered as a workplace file; and
generating workplace file access information as information specifying an individual accessing the workplace file and time.

9. A non-transitory recording medium storing a computer readable program executed by a computer for managing time when a file is used for working, the program causing the computer to perform:
generating workplace file information in which a file satisfying a condition set in advance in files stored in a storage device is registered as a workplace file; and
generating workplace file access information as information specifying an individual accessing the workplace file and time.
